(19) United States
(12) Patent Application Publication
(10) Pub. No.: US 2007/0151922 A1
(43) Pub. Date: Jul. 5, 2007

(54) Spiral Speed Separator (SSS)

(76) Inventor: Farouk Aslam Mian, Houston, TX (US)

Correspondence Address: FAROUK ASLAM MIAN, 4218 SUN MEADOW DRIVE, HOUSTON, TX, 77072-1455, US

(21) Appl. No.: 11/325,068

(22) Filed: Jan. 5, 2006

(51) Int. Cl. B01D 21/26

(52) U.S. Cl. 210/512.1; 55/459.1

(57) ABSTRACT

The principle for the Spiral Speed Separator is the combination of tangential, centrifugal and gravitational forces, which results in a far more effective and superior separation for the removal of vapors or gases from liquids, solids from liquids, and solids from gases.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

The conventional configuration includes the separator, which resembles a drum. It can be either in a horizontal or a vertical shape and is known as a knock out drum, reflux drum, vapor liquid or solid separator. The mixtures of vapor-liquid, solid-liquid, and solid-gas are allowed to enter for separation from each other. The separation in most cases is less effective and results in lower separation efficiencies. Even with the cyclone separator, there is still a lot of carry over due to entrainment because of the short span from the inlet to top side outlet.

### BRIEF DESCRIPTION OF THE SEVERAL VIEWS OF THE DRAWING

FIG. 1—This is a diagram of the Spiral Speed Separator

FIG. 2—This is a diagram of the Spiral Speed Mixer.

### DETAILED DESCRIPTION OF INVENTION

The invention relates to a unique method efficiently separation of various streams or fluids such as:
Gases or Vapors from Liquids
Gases or Vapors from Solids
Liquids from Solids

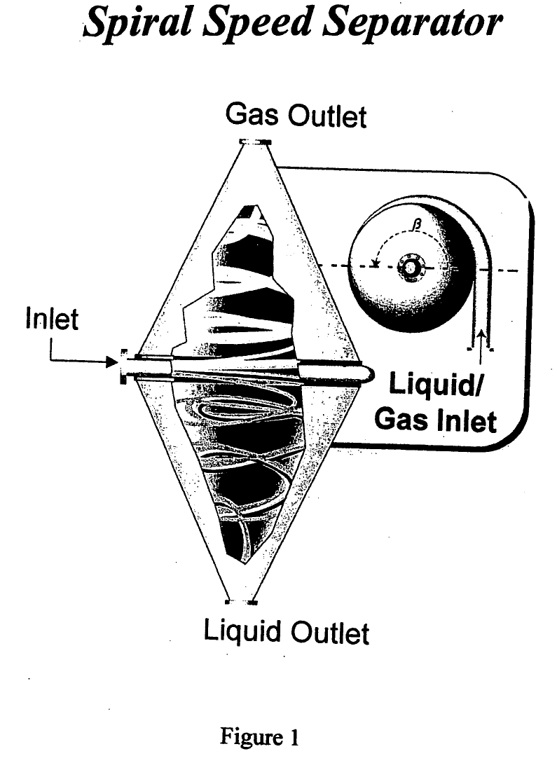

The combination and creation of the fluid's centrifugal and gravitational forces through a tangential projection with the directional vanes in both zones with equal distance and volume is the basis for the Spiral Speed Separator. The angle of the tangential flow is shown by the angle β in the FIG. 1. The fluids' kinetic energy is used to create all the effects which result in efficient separation than the conventional systems. This phenomenon will result in a far superior separation among the different fluids and also highly efficient for mixing and blending different fluids.

1) I claim the Spiral Speed Separator device to be very efficient in separation of gases or vapors from liquids.

2) I claim the Spiral Speed Separator device to be very efficient in separtion of gases or vapors from solids.

3) I claim the Spiral Speed Separator device to be very efficient in separation of liquids from solids.

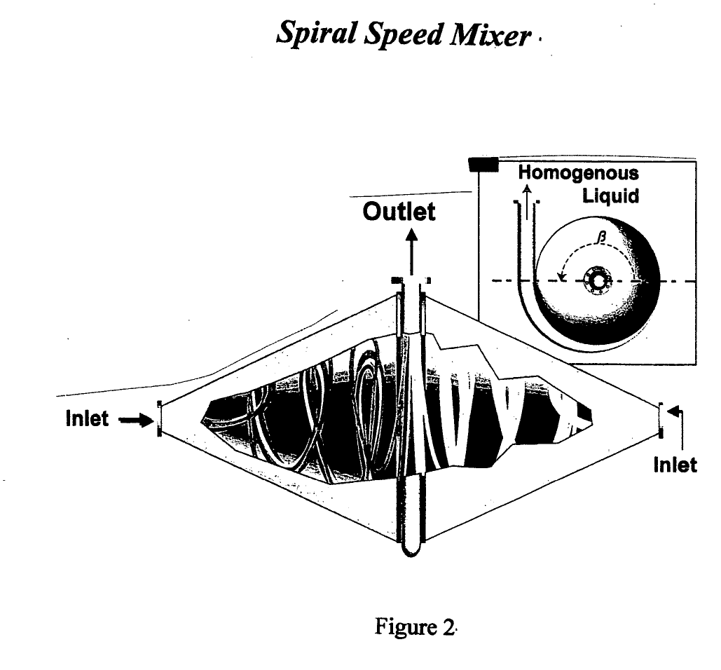

4) I claim the Spiral Speed Mixer (SSM) device to be very efficient in blending various liquids injecting through two inlets and receiving through the tangential single outlet as shown in FIG. 2.
